(19) United States
(12) Patent Application Publication
(10) Pub. No.: US 2024/0337036 A1
(43) Pub. Date: Oct. 10, 2024

(54) METHOD FOR OPERATING AN ELECTROLYSIS PLANT, AND ELECTROLYSIS PLANT

(71) Applicant: Siemens Energy Global GmbH & Co. KG, München (DE)

(72) Inventors: Du-Fhan Choi, Düsseldorf (DE); Dirk Wall, Mülheim (DE); Markus Ungerer, Baiersdorf (DE); Erik Wolf, Röttenbach (DE)

(21) Appl. No.: 18/576,462

(22) PCT Filed: May 5, 2022
(86) PCT No.: PCT/EP2022/062152

§ 371 Date: Jan. 4, 2024

(30) Foreign Application Priority Data
Jul. 19, 2021 (EP) 21186286.7

(51) Int. Cl. C25B 15/08; C25B 1/04; C25B 15/029

(52) U.S. Cl. CPC C25B 15/083; C25B 1/04; C25B 15/029; C25B 15/081

(57) ABSTRACT

The invention relates to a method for operating an electrolysis plant for producing hydrogen and oxygen as product gases, wherein the hydrogen product gas, which additionally contains oxygen as a foreign gas, is fed from an electrolyser to a downstream gas separator, wherein when a predefined limit value for the oxygen concentration in the hydrogen product gas is exceeded, hydrogen having a low oxygen concentration is fed to the gas separator such that the oxygen concentration in the hydrogen product gas is lowered. The invention further relates to a corresponding electrolysis plant.

### BACKGROUND

The invention relates to a method for operating an electrolysis system comprising an electrolyzer for generation of hydrogen and oxygen as product gases. The invention further relates to such an electrolysis system.

Hydrogen is nowadays produced, for example, by means of proton exchange membrane (PEM) electrolysis or alkaline electrolysis. The electrolyzers produce hydrogen and oxygen from the supplied water with the aid of electrical energy.

An electrolyzer generally comprises a multiplicity of electrolytic cells arranged adjacently to one another. In the electrolytic cells, water is decomposed into hydrogen and oxygen by means of water electrolysis. In the case of a PEM electrolyzer, distilled water as reactant is typically supplied on the anode side and split into hydrogen and oxygen at a proton exchange membrane (PEM). This involves oxidation of the water at the anode to form oxygen. The protons pass through the proton exchange membrane. Hydrogen is produced on the cathode side. The water is generally conveyed into the anode space and/or cathode space from a bottom side.

This electrolysis process takes place in the so-called electrolysis stack, composed of multiple electrolytic cells. In the electrolysis stack which is under DC voltage, water is introduced as reactant, and passage through the electrolytic cells is followed by the exit of two fluid streams consisting of water and gas bubbles (oxygen O₂ or hydrogen H₂).

In practice, the oxygen gas stream contains small amounts of hydrogen and the hydrogen gas stream contains small amounts of oxygen. The quantity of the respective foreign gas depends on the electrolytic cell design and also varies under the influence of current density, catalyst composition and aging and, in the case of a PEM electrolysis system, depends on the membrane material. Inherent to the system is the fact that the gas stream of one product gas contains the other product gas in very low amounts. In the further course of the process, even small traces of oxygen are generally removed from the hydrogen in downstream gas cleaning steps using in some cases very complex and cost-intensive cleaning steps, in particular if a particularly high quality of product gas is required, as is the case for instance when utilizing the hydrogen for, for example, fuel cells.

Such an electrolysis system having a downstream gas cleaning system is shown, for example, in WO 2020/095664 A1. The hydrogen product gas which is produced in an electrolyzer during electrolysis and which also contains oxygen as foreign gas is first supplied to a gas separator. After the water component in the gas separator has been removed, the hydrogen product gas is guided out of the gas separator via a product gas line and completely transferred to a cleaning system, through which the hydrogen product gas flows repeatedly and cyclically. In the cleaning system, the oxygen is removed from the hydrogen product gas by reaction of the oxygen in a recombination catalyst (DeOxo catalyst) with the hydrogen to form water. As a result of the cyclical application, oxygen is virtually completely removed from the hydrogen product gas, thus lastly providing hydrogen of high quality and purity. In WO 2020/095664 A1, the system comprises connection of an electrolyzer, a gas separator and the DeOxo catalyst in series. The series connection allows highly efficient removal, transfer and subsequent cleaning of the hydrogen product gas in the gas separator. For particularly high gas purity, the cleaning system comprising the Deoxo catalyst is passed through multiple times via an intermediate tank through cleaning steps carried out multiple times in a loop. Lastly, the hydrogen brought to a desired high purity and accordingly purified is transferred to a tank and stored/kept ready for further purposes.

In general, it is possible in this way in an electrolysis system, for gas cleaning of the product gas streams from the electrolyzer, to supply both product gas streams in particular to a respective, catalytically activated recombinator in which a catalyst allows recombination of the hydrogen with the oxygen to form water (DeOxo unit). To this end, the gas stream must be heated beforehand to at least 80° C. in order for the conversion rates of the recombinator to be sufficiently high and for the required gas purity to be thus achieved. However, the processing system used for this purpose is costly and, because of its energy demand, reduces the system efficiency of the entire electrolysis system. Therefore, attention must already be paid to the purity and quality of the product gas streams which are initially produced in the electrolyzer and discharged from the electrolyzer, not only for operational safety, but also to keep the costs and complexity for the subsequent cleaning steps within reasonable limits.

The purity and quality of the product gas streams of the gas originally produced in the electrolyzer is dependent on many parameters and can also change in the course of operation of an electrolysis system. It is a problem here if the concentration of oxygen in hydrogen increases. If a certain concentration limit is exceeded here, in particular in the gas separator (container) immediately downstream of the electrolysis, the hydrogen gas produced can no longer be transferred for further purposes. If the proportion of oxygen increases further, a combustible or explosive mixture may even form. The gas separator (container) is then in a potentially dangerous operational state that must be absolutely avoided for safety reasons.

Reliable and continuous monitoring of gas quality during operation on the hydrogen side, i.e., monitoring of the concentration of oxygen as foreign gas in the hydrogen produced just before a complex downstream gas cleaning system (DeOxo unit), is an important protective measure here for detecting critical operational states and for taking safety measures right through to shutdown of the system.

It is therefore an object of the invention to allow improved operation with respect to safety and system efficiency in the case of an electrolysis system.

### SUMMARY

Embodiments include a method for operating an electrolysis system for generation of hydrogen and oxygen as product gases, in which the hydrogen product gas from an electrolyzer that also contains oxygen as foreign gas is supplied to a downstream gas separator, wherein hydrogen of a low oxygen concentration is removed from a buffer tank and supplied to the gas separator as needed when a predetermined limit for the oxygen concentration in the hydrogen product gas is exceeded, so that the oxygen concentration in the hydrogen product gas is lowered.

### DETAILED DESCRIPTION

According to the invention, the object is achieved by a method for operating an electrolysis system for generation of hydrogen and oxygen as product gases, in which the hydrogen product gas from an electrolyzer that also contains oxygen as foreign gas is supplied to a downstream gas separator, wherein hydrogen of a low oxygen concentration is removed from a buffer tank and supplied to the gas separator as needed when a predetermined limit for the oxygen concentration in the hydrogen product gas is exceeded, so that the oxygen concentration in the hydrogen product gas is lowered.

According to the invention, the object is further achieved by an electrolysis system comprising an electrolyzer for generation of hydrogen and oxygen as product gases, in which the hydrogen product gas also contains oxygen as foreign gas, in which the electrolyzer is connected to a gas separator via a product stream line for the hydrogen product gas and the gas separator is connected to a buffer tank via a supply line, wherein the buffer tank is designed to supply hydrogen of a low oxygen concentration to the gas separator as needed, there being connected into the supply line a valve which is designed as a bidirectional control valve, so that loading of the buffer tank with hydrogen product gas is performable in normal operation and hydrogen product gas is suppliable as needed to the gas separator in an exact metered amount, there being settable in the gas separator a desired dilution of the oxygen as foreign gas.

The advantages and preferred embodiments mentioned below in relation to the method can be applied, mutatis mutandis, to the electrolysis system.

The invention is based just on the finding that prior operating concepts for electrolysis systems with respect to monitoring and remedying critical operational states in relation to the quality of the hydrogen produced are complex and are considerably disadvantageous economically.

In prior operating concepts, quality measurement is usually achieved by measuring and monitoring the concentration of oxygen in the hydrogen product gas in the gas separator. If the concentration exceeds a predetermined limit, the operation of the electrolyzer is stopped and the entire hydrogen product gas in the gas separator is discarded. The hydrogen product gas is completely discharged from the container volume of the gas separator and any supply lines of the hydrogen-side gas system. To this end, the gas separator is completely vented. The entire gas system including gas separator is then purged by a complex purging procedure for inertization with nitrogen from a storage container in the nitrogen system of the electrolysis system. For this nitrogen demand that is relevant to safety, the nitrogen system must accordingly be of a large volume in order to hold sufficient nitrogen available. After the cause of the critical quality of the hydrogen product gas has been addressed, the electrolysis is restarted. Owing to the inert gas nitrogen in the gas system, the newly produced hydrogen product gas must initially also be discarded, specifically until the desired gas quality has been reached again. It is thus particularly disadvantageous from an economical point of view to hold available a large-volume nitrogen inertization system and nitrogen stockpile and especially also discard the hydrogen product gas produced.

The present invention specifically proceeds from here by reducing a critical concentration of oxygen foreign gas in the hydrogen product gas in the gas separator downstream of the electrolyzer by removing hydrogen of better quality, i.e., of a low oxygen concentration, from a buffer tank and supplying it in a specific manner and a correctly metered manner with respect to the hydrogen to the gas separator to the hydrogen product gas. The supply brings about mixing of the gases in the gas separator, thereby achieving lowering of the oxygen concentration. The oxygen concentration is reduced solely because of the effect of gas mixing and dilution of the oxygen in the hydrogen product gas, which effect is exploited particularly advantageously in the invention. What is thus avoided is discarding of the hydrogen product gas in the gas separator, since it remains in this container in the presently proposed procedure. The gas volume can therefore be used when starting up the electrolyzer again. The hydrogen yield of the electrolysis system is increased, since there is practically no discarding of high-value hydrogen that has already been produced. Also, the complex and complete inertization of the gas system, in particular the gas separator, with nitrogen can be dispensed with and a nitrogen system on the electrolysis system that is still required can accordingly be dimensioned smaller.

In an embodiment of the method, the pressure in the gas separator is lowered in such a way that a pressure difference achieved thereby causes hydrogen of a low oxygen concentration to flow from the buffer tank into the gas separator. As a result, supply of hydrogen of good quality and purity into the gas separator is achieved in a particularly simple manner. A pressure difference can preferably be generated, for instance, by partial and only slight discharge of hydrogen product gas in the gas separator. Alternatively, it is also possible to achieve a flow into the gas separator for dilution by setting an appropriate higher pressure level of the supplied hydrogen.

Advantageously, the oxygen concentration in the gas separator is measured. The oxygen concentration is measured and monitored using appropriately sensitive gas sensors, preference also being given to using monitoring and control units for selective gas sensor analysis in order to determine and monitor the oxygen concentration in the hydrogen product gas “in situ” reliably. This applies not only to the regular operation of the electrolysis system, but also advantageously during the procedure of lowering the oxygen concentration in the hydrogen product gas below the desired and predetermined critical limit.

In the method, the hydrogen of low oxygen concentration is removed as needed from a buffer tank in which hydrogen product gas of high purity and quality is stockpiled and has a low oxygen foreign gas component. What is thus achieved is that hydrogen for dilution and lowering of the oxygen concentration is supplied only as needed. The buffer tank has been loaded with hydrogen product gas of good quality, i.e., of low or very low concentration of oxygen foreign gas. In the buffer tank, an appropriate supply of gas is stored or held available. The buffer tank is in the form of a container which has been designed and constructionally adapted as required with respect to volume. Advantageously, the buffer tank has been loaded with hydrogen product gas during normal operation of the electrolyzer, i.e., during the electrochemical decomposition of water into hydrogen and oxygen, so that a supply of hydrogen product gas of good quality is held available in the buffer tank. It is also possible that there is a continuous flow through the buffer tank during normal operation of the electrolyzer, so that a volume is available at all times should the gas quality worsen above the critical value of a still tolerable oxygen concentration.

Therefore, advantageously, hydrogen product gas of an oxygen concentration below the predetermined limit for the oxygen concentration is supplied to the buffer tank. Preferably, hydrogen product gas from the gas separator is supplied to the buffer tank. As described, it is possible and advantageous during normal operation of the electrolyzer to load the buffer tank with hydrogen product gas of good quality, i.e., of low oxygen concentration.

Advantageously, a buffer tank is incorporated in the operating concept of the electrolysis system upstream of the gas separator. Said buffer tank is usually under a pressure and contains hydrogen of a good quality.

Based on a determined that the quality measurement in the gas separator indicates a poor quality, the electrolysis process is stopped. Instead, now, of discarding the gas in the gas separator, the pressure in the separator is lowered only to the extent that clean gas is supplied again to the gas separator from the buffer tank. Clean hydrogen gas is supplied to the gas separator until the gas quality is adequate, i.e., the oxygen concentration is less than the predetermined limit.

In a further embodiment of the method, hydrogen of high purity is removed from a second buffer tank and supplied to the gas separator.

In this connection, hydrogen of high purity means that the contamination of the hydrogen stored in the second buffer tank by oxygen foreign gas is even lower than the gas quality of the hydrogen product gas in the gas separator. It is found to be particularly advantageous here that the desired dilution and thus improvement in quality of the hydrogen product gas is achieved by having to supply an amount of hydrogen of high purity that is lower compared to supply from the buffer tank. A lower gas volume is required. The respective removal of hydrogen and respective supply from the buffer tank and the second buffer tank is also flexibly combinable.

In an embodiment, hydrogen of low oxygen concentration from the buffer tank is supplied to a recombinator containing a catalyst, so that the oxygen recombines with the hydrogen to form water, yielding hydrogen of high purity which is used to load the second buffer tank. The hydrogen of high purity, i.e., of an at most very low concentration of oxygen foreign gas or of no appreciable oxygen concentration from a practical point of view, is thus advantageously obtained during operation of the electrolysis system itself. Owing to the advantageous catalytic gas cleaning step, the gas quality in the second buffer tank is very good and distinctly better again than in the buffer tank.

In an embodiment, the generation of hydrogen and oxygen in the electrolyzer is stopped. Normal operation is thus advantageously interrupted only until has been achieved by supplying catalytically cleaned hydrogen of high purity from the second buffer tank, or hydrogen product gas of a low oxygen concentration from the buffer tank, into the gas separator for dilution and lowering of the oxygen concentration below the limit. As a result, the required maintenance time with associated downtime of the electrolyzer for the method according to the invention is advantageously considerably reduced compared to the conventional methods. These involve a complete discharge of the hydrogen product gas, with emptying of the gas separator followed by complete inertization of the gas system with nitrogen and lastly startup of the electrolysis system again until a normal operating state of the electrolyzer is reached or resumed.

The electrolysis system according to the invention comprises an electrolyzer for generation of hydrogen and oxygen as product gases, in which the hydrogen product gas also contains oxygen as foreign gas, the electrolyzer being connected to a gas separator via a product stream line for the hydrogen product gas and the gas separator being connected via a supply line to a buffer tank which is designed to supply hydrogen of a low oxygen concentration to the gas separator as needed. Connected into the supply line is a bidirectional control valve, so that loading of the buffer tank with hydrogen product gas is performable in normal operation. Hydrogen product gas is suppliable as needed to the gas separator in an exact metered amount, in particular during shutdown operation. Settable in the gas separator as a result is a desired dilution of the oxygen as foreign gas.

The buffer tank is preferably in the form of a container and, as further explained above for the method, pressurizable and thus fillable with hydrogen containing a low concentration of oxygen as foreign gas. The buffer tank advantageously serves as a store of hydrogen product gas of appropriate gas quality. Hydrogen of good quality is suppliable from the buffer tank into the gas separator through the supply line.

Connected into the supply line is a valve which is designed as a bidirectional control valve. The design of the valve as a control fitting allows accurate metering of the gas supply to the gas separator. The valve position of the control valve can advantageously be controlled by a hydraulic or electromechanical valve control or valve control device.

The valve is designed as a control valve or control fitting through which flow is possible in both directions. The bidirectional configuration of the control valve allows a particularly flexible mode of operation and change of operating mode with, firstly, loading of the buffer tank, for example during normal operation of the electrolyzer in which hydrogen product gas is supplied to the buffer tank and said buffer tank is loadable. Secondly, hydrogen product gas is suppliable as needed to the gas separator in the opposite direction through the supply line during shutdown operation of the electrolyzer. Owing to this configuration, the electrolysis system is designed in such a way that, for example, a sudden, gradual, once-only or sustained change in the gas quality of the hydrogen product gas in the gas separator can be responded to in a flexibly rapid manner and in a controlled manner. The metered addition brings about the desired dilution effect, and so a lower value of the concentration of oxygen as foreign gas in the hydrogen product gas in the gas separator is settable. Advantageously, owing to the bidirectional configuration of the control valve, the supply line is usable in both flow directions, which has cost advantages.

In an embodiment, there is provided a bypass line which has a shut-off valve and which branches off from the supply line and is fluidically connected parallel to the supply line in such a way that the bypass line circumvents the valve, in particular the control valve.

In an embodiment of the electrolysis system, it comprises a second buffer tank which is connected to the buffer tank via a line, there being connected into the line a recombinator containing a catalyst, so that the oxygen is recombinable with the hydrogen to form water and hydrogen of high purity for loading of the second buffer tank is obtainable.

The second buffer tank is preferably connected to the gas separator via a supply line, so that supply of hydrogen of high purity from the second buffer tank to the gas separator is achievable as needed. A valve which is in particular designed as a control valve is connected into the supply line, and it is preferably designed for bidirectional operation. This embodiment serves for precise metering of cleaned hydrogen product gas of a high quality and purity and for controlled supply into the gas separator via the supply line.

### BRIEF DESCRIPTION OF THE FIGURES

Exemplary embodiments of the invention will be more particularly elucidated on the basis of a drawing, where:

FIG. 1 shows an electrolysis system comprising a nitrogen system for inertization,

FIG. 2 shows an electrolysis system comprising a hydrogen buffer tank according to the invention,

FIG. 3 shows a further exemplary embodiment of an electrolysis system comprising a buffer tank according to the invention, and

FIG. 4 shows a further exemplary embodiment of an electrolysis system comprising a gas cleaning and a further buffer tank, each of which is shown in schematic and greatly simplified form.

In the figures, the same reference signs have the same meaning.

### DETAILED DESCRIPTION OF THE FIGURES

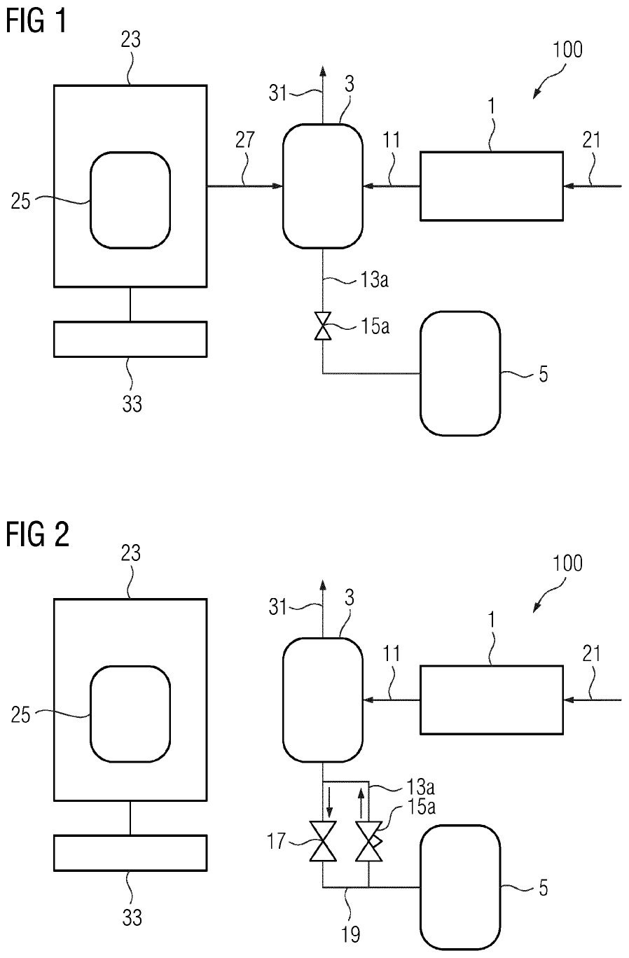

FIG. 1 depicts an electrolysis system 100 in a greatly simplified detail of system components. The electrolysis system 100 comprises an electrolyzer 1 configured from a PEM electrolyzer or alkaline electrolyzer. The electrolyzer 4 comprises at least one electrolytic cell for electrochemical decomposition of water that is not further shown here. Moreover, the electrolysis system 100 comprises a nitrogen system 23 which comprises a nitrogen container 25. A compressor 33 is connected to the nitrogen system 23 to supply the nitrogen system 23. The nitrogen system 23 is connected to a gas separator 3 via a purge line 27, so that nitrogen for purging of the gas separator 3 is removed from the nitrogen container 25 and suppliable to the gas separator 3 (nitrogen inertization) as needed. For the nitrogen demand in the electrolysis system 100, the nitrogen container 25 is accordingly dimensioned and pressurized with a large volume. Besides other functions, large amounts of nitrogen, which are to be held available in the nitrogen container 25, are required for inertization as needed.

In the electrolyzer 1, a reactant stream composed of water is introduced via a reactant stream line 21. The water is electrochemically decomposed in the electrolyzer 1 into the product gases hydrogen and oxygen and both product streams are separately conducted out of the electrolyzer 1. To conduct out the hydrogen product stream, the electrolyzer 1 has a product stream line 11, by means of which a first product, in this case hydrogen, is guided out. The presently described structure of the electrolysis system 100 is based on the hydrogen product stream. However, on the oxygen side, a similar system structure can be present in the electrolysis system 100, which is not further shown and explained in FIG. 1 for the sake of clarity. The electrolyzer 1 is connected to a gas separator 3 via the product stream line 11. Connected to the gas separator 3 is a venting line 31, via which the gas separator 3 can be emptied. Furthermore, a buffer tank 5 is connected to the gas separator 3 via a supply line 13a, arranged in which is a valve 15a. Hydrogen product gas from the electrolysis is suppliable to the buffer tank 5 from the gas separator 3 via the supply line 13a. In this way, the buffer tank 5 is loaded with hydrogen product gas for further purposes, in particular gas cleaning.

During operation of the electrolyzer 1 in the system concept of FIG. 1, hydrogen product gas is supplied to the gas separator 3. In this operating concept, measurement of the quality of the hydrogen product gas is achieved by measuring and monitoring the concentration of oxygen in the hydrogen product gas in the gas separator 3. If the concentration exceeds a predetermined limit, the operation of the electrolyzer 1 is stopped and the entire hydrogen product gas in the gas separator is discarded. The hydrogen product gas is completely discharged from the container volume of the gas separator 3 and any supply lines of the hydrogen-side gas system. To this end, the gas separator 3 is completely vented via the venting line 31. The entire gas system including gas separator 3 is then purged by a complex purging procedure for inertization with nitrogen from a nitrogen container 25 in the nitrogen system 23 of the electrolysis system 100. For this nitrogen demand that is relevant to safety, the nitrogen system 23 must accordingly be of a large volume in order to hold sufficient nitrogen available. After the cause of the critical quality of the hydrogen product gas has been addressed, the electrolysis is restarted. Owing to the inert gas nitrogen in the gas system and, in particular, in the gas separator 3, the newly produced hydrogen product gas must initially also be discarded, specifically until the desired gas quality has been reached again. It is thus particularly disadvantageous from an economical point of view to hold available a large-volume nitrogen inertization system and sufficient nitrogen stockpile and especially also discard the hydrogen product gas produced.

The new operating concept of the invention proceeds from here with an advantageous incorporation of the buffer tank 5 downstream of the gas separator 3, as will be further elucidated below in FIG. 2. Compared to the embodiment of the electrolysis system 100 according to FIG. 1, the connection of the nitrogen system 23 to the gas separator 3 via the purge line 27 for inertization with nitrogen is dispensed with. The buffer tank 5 is usually under pressure and contains hydrogen product gas of a low oxygen concentration from the electrolysis, i.e., hydrogen product gas of a good quality and accordingly of low concentration of foreign gas. The buffer tank 5 is fluidically connected to the gas separator 3 via the supply line 13a. Connected into the supply line 13a is a valve 15a which is designed as a control valve. The design of the valve 15a as a control fitting achieves highly accurate metering of the gas supply to the gas separator 3. The valve position of the valve 15a is provided with a hydraulic or electromechanical valve control and is controllable by a valve control device. A bypass line 19 branches off from the supply line 13a and is fluidically guided parallel to the supply line 13a, with the bypass line 19 circumventing the valve 15a. Connected into the bypass line is a shut-off valve 17 which is designed as an automatic shut-off valve. Thus, there is no valve 17 with control function provided for the flow of hydrogen product gas from the gas separator 3 to the buffer tank 5 for loading thereof during normal operation of the electrolyzer 1, which is a cost advantage. Setting of pressure on the hydrogen side can be performed elsewhere, for instance by setting the pressure in the gas separator 3, overflow of hydrogen product gas from the gas separator 3 through the bypass line 19 into the buffer tank 5 is achieved in a simple manner. The valve 15a is designed as a control valve to supply or return hydrogen of a low oxygen concentration, i.e., of good quality, from the buffer tank 5 into the gas separator 3 as needed in a correctly metered and controlled manner. Because of the relatively low volumetric flow rates for dilution that are generally required, said valve 15a can accordingly be dimensioned smaller and cost-effectively, in particular with respect to the necessary flow diameter.

Now, in the event of a critical concentration of foreign gas during operation, the proportion of oxygen in the hydrogen product gas in the gas separator 3 downstream of the electrolyzer 1 is reduced by supplying hydrogen of better quality, i.e., of a low oxygen concentration, to the hydrogen product gas in a specific and correctly metered manner. This specific supply then brings about mixing of the gases in the gas separator 3, thereby achieving lowering of the oxygen concentration. The oxygen concentration is reduced solely because of the effect of gas mixing and dilution of the oxygen in the hydrogen product gas, which effect is exploited particularly advantageously in the invention. What is thus avoided is discarding of the hydrogen product gas in the gas separator 3, since it remains in this container in the presently proposed procedure. The gas volume can therefore be used when starting up the electrolyzer again.

Based on a determination that the quality measurement in the gas separator 3 indicates a poor quality, the electrolysis process is stopped. Instead, now, of discarding the gas in the gas separator 3, the pressure in the gas separator 3 is lowered only to the extent that clean hydrogen gas is supplied again to the gas separator 3 from the buffer tank 5. Clean hydrogen gas is supplied to the gas separator 3 until the gas quality is good, i.e., the oxygen concentration is less than the predetermined limit.

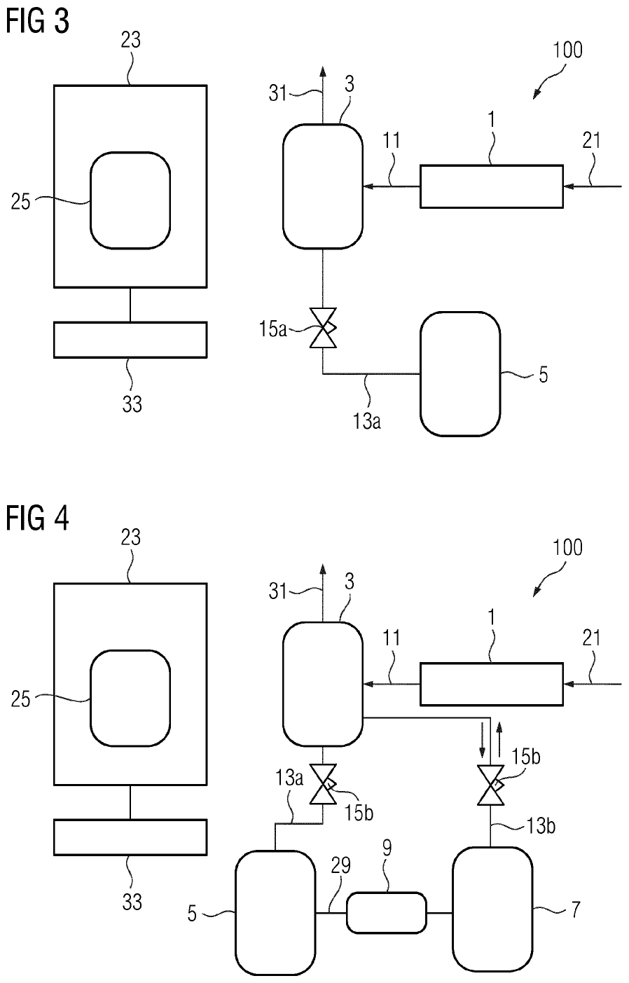

In a further advantageous embodiment of the electrolysis system 100 according to FIG. 3, even the bypass line 19 is dispensable compared to FIG. 2. To this end, the valve 15a designed as a control valve through which flows is possible in both directions, i.e., a bidirectional control fitting, is used in the supply line 13a. The bidirectional configuration of the valve 15a as a control valve allows a particularly flexible mode of operation and change of operating mode with, firstly, loading of the buffer tank 5 during normal operation of the electrolyzer 1 in which hydrogen product gas is suppliable to the buffer tank and said buffer tank is loadable. Secondly, hydrogen product gas is suppliable as needed to the gas separator 3 in the opposite direction during shutdown operation of the electrolyzer 1.

In a further embodiment and flexible development of the invention, FIG. 4 shows that a hydrogen of high purity obtained in a gas cleaning step is suppliable to the gas separator 3 via a valve 15b. To this end, a second buffer tank 7 containing hydrogen of high purity is provided and is integrated into the electrolysis system 100. The second buffer tank 7 is connected to the buffer tank 5 via a line 29 and is fluidically downstream of the buffer tank 5. Integrated into the line 29 is a recombinator 9, a so-called DeOxo unit, where a gas cleaning step is performable on the hydrogen product gas from the buffer tank 5. To this end, the hydrogen product stream is supplied to the recombinator 3, which contains platinum or radium as catalyst material. The catalyst is advantageously applied to a ceramic or metallic support. In the recombinator 3, the catalyst allows recombination of the hydrogen with the oxygen, thus producing water. The product stream is then cooled in a cooling device not further depicted, since the reaction proceeds exothermically in the recombinator 3. The second buffer tank 7 is thereby loadable with hydrogen of particularly high purity with regard to contamination with oxygen foreign gas, since the gas quality is distinctly improved after the catalytic gas cleaning in the recombinator 9. In order to control the recombination process in the exemplary embodiment shown, a pressure p and a temperature T of the hydrogen product gas is preferably measured both at the inlet and the outlet of the recombinator 3 and supplied to a control unit not further depicted.

Since the gas quality is distinctly better after the gas cleaning process, less volumetric flow is required to supply hydrogen from the second buffer tank 7 into the gas separator 3 in order to achieve the desired dilution effect in the gas separator 3 with respect to the desired reduction of the oxygen concentration below the predetermined limit. Accordingly, according to FIG. 4, there is provided the line 29 as a connection between gas separator 3 and the cleaned hydrogen in the second buffer tank 7.

Connected into the line 29 is a valve 15b which is designed as a control fitting. As a result, an interruption to operation can be avoided, irrespective of whether the gas quality changes suddenly or gradually and also irrespective of the timescale in which this state occurs or continues. A timeframe for more flexible service planning is thus created and, in particular, servicing and maintenance that must be carried out on the electrolysis system 1 from time to time are better plannable.

For the connection between gas separator and the buffer tank 3 as well, this means higher constructional flexibility of the system design of the electrolysis system 100 such that the valve 15a can, now, be designed as a shut-off valve in a cost-effective variant (see FIG. 1). In this case, what should preferably be done, irrespective of the error pattern causing the worsened gas quality, be it a sudden or gradual, once-only or longer-lasting exceeding of the limit of the oxygen concentration, is to dilute the hydrogen product gas in the gas separator 3 via the second buffer tank 5 after the gas cleaning step in the recombinator 7.

In an alternative embodiment, the fitting in the supply line 13a between gas separator 3 and buffer tank 5 can also be designed according to FIG. 2 or FIG. 3 and thus allows many degrees of freedom and handling options for operation management that is matched to the fault.

As a particularly economical advantage, it is found that the nitrogen system 23 can be configured distinctly more compactly owing to the proposed system concept for the electrolysis system 100. With the concept, it is sufficient to only provide continuous nitrogen consumption for so-called compressor operation.

The amount of nitrogen required for service purposes for the gas separator 3 can, for example, be provided via nitrogen cylinders or via a nitrogen tank, which is determined by the volume of the gas separator 3 as before, but can now be filled very slowly during normal operation. This is especially because maintenance can be better planned and because there is no longer a need for the conventional approach of holding available twice the nitrogen volume required as needed in the event of a (repeated) error shutdown during startup or just afterwards. This fault can be dealt with very economically with the procedure described above.

1. A method for operating an electrolysis system for generation of hydrogen and oxygen as product gases, in which the hydrogen product gas from an electrolyzer that also contains oxygen as foreign gas is supplied to a downstream gas separator, wherein hydrogen of a low oxygen concentration is removed from a buffer tank and supplied to the gas separator as needed when a predetermined limit for the oxygen concentration in the hydrogen product gas is exceeded, so that the oxygen concentration in the hydrogen product gas is lowered.

2. The method as claimed in claim 1, in which the pressure in the gas separator is lowered in such a way that a pressure difference achieved thereby causes hydrogen of a low oxygen concentration to flow from the buffer tank into the gas separator.

3. The method as claimed in claim 1, in which the oxygen concentration in the gas separator is measured.

4. The method as claimed in claim 1, wherein hydrogen product gas of an oxygen concentration below the predetermined limit for the oxygen concentration is supplied to the buffer tank.

5. The method as claimed in claim 1, wherein hydrogen product gas from the gas separator is supplied to the buffer tank.

6. The method as claimed in claim 1, in which hydrogen of high purity is removed from a second buffer tank and supplied to the gas separator.

7. The method as claimed in claim 6, in which hydrogen of low oxygen concentration from the buffer tank is supplied to a recombinator containing a catalyst, so that the oxygen recombines with the hydrogen to form water, yielding hydrogen of high purity which is used to load the second buffer tank.

8. The method as claimed in claim 1, in which the generation of hydrogen and oxygen in the electrolyzer is stopped.

9. An electrolysis system comprising an electrolyzer for generation of hydrogen and oxygen as product gases, in which the hydrogen product gas also contains oxygen as foreign gas, the electrolyzer being connected to a gas separator via a product stream line for the hydrogen product gas and the gas separator being connected to a buffer tank via a supply line,
characterized in that the buffer tank is designed to supply hydrogen of a low oxygen concentration to the gas separator as needed, there being connected into the supply line a valve which is designed as a bidirectional control valve, so that loading of the buffer tank with hydrogen product gas is performable in normal operation and hydrogen product gas is suppliable as needed to the gas separator in an exact metered amount, there being settable in the gas separator a desired dilution of the oxygen as foreign gas.

10. The electrolysis system as claimed in claim 9, comprising a bypass line which has a shut-off valve and which branches off from the supply line and is fluidically connected parallel to the supply line in such a way that the bypass line circumvents the valve.

11. The electrolysis system as claimed in claim 9, comprising a second buffer tank which is connected to the buffer tank via a line, there being connected into the line a recombinator containing a catalyst, so that the oxygen is recombinable with the hydrogen to form water and hydrogen of high purity for loading of the second buffer tank is obtainable.

12. The electrolysis system as claimed in claim 11, wherein the second buffer tank is connected to the gas separator via a supply line, so that supply of hydrogen of high purity from the second buffer tank to the gas separator is achievable as needed.

13. The electrolysis system as claimed in claim 12, wherein a valve which is in particular designed as a control valve is connected into the supply line.
